(19) United States
(12) Patent Application Publication
(10) Pub. No.: US 2023/0377072 A1
(43) Pub. Date: Nov. 23, 2023

(54) Method of Creating Equitable Commercial Real Estate Lease Structures

(71) Applicant: Hughes Marino, Inc., San Diego, CA (US)

(72) Inventor: Kevin Brennen, San Francisco, CA (US)

(21) Appl. No.: 18/190,858

(22) Filed: Mar. 27, 2023

Related U.S. Application Data
(60) Provisional application No. 63/269,983, filed on Mar. 27, 2022.

(51) Int. Cl. G06Q 50/16

(52) U.S. Cl. CPC G06Q 50/165

(57) ABSTRACT

A method that integrates risk-adjusted return metrics into a practical application of creating equitable commercial real estate equity structures that benefit both a tenant and its commercial property owner partner involves the use of risk-adjusted return metrics to determine the tenant's impact on real estate equity. An equity structure is then created in which the tenant “buys in,” lowering risk to its landlord partners. By stabilizing future value, the tenant is able to “buy down” its commercial real estate profit and loss or present value cost to wholesale pricing, resulting in savings of thirty-five to fifty percent over market rates. The lease is made equitable through a one-to-one ratio of total lease obligation to tenant equity impact.

### RELATED APPLICATION

This application claims priority to U.S. Provisional Patent Application Ser. No. 63/269,983 for a “Method of Creating Equitable Commercial Real Estate Lease Structures,” filed Mar. 27, 2022, and currently co-pending, the entirety of which is incorporated herein by reference.

### FIELD OF THE INVENTION

The present invention pertains generally to a practical application of risk-adjusted return metrics in commercial real estate.

### BACKGROUND OF THE INVENTION

Commercial real estate investors purchase property with the expectation of a return on their investment over time through income generated by the purchased property. As a result, most of the value of commercial real estate is tied up in expected income and equity. In determining the value of the investment, consideration must be given to risks, such as vacancies, and operating costs.

An investor generally purchases a commercial real estate property when the expected income and terminal value of the property is anticipated to provide a profit, Present value versus future value, as well as factors such as inflation, risks, and operating costs, must be considered in predicting whether the investment will be profitable.

However, the commercial real estate market focuses almost exclusively on the above. It is thus primarily oriented around the needs of the investor-landlord, virtually to the exclusion of tenant or lessee interests, even when tenants create value for the landlord. It would therefore be advantageous to provide an approach to tenant leasing and tenant real estate oriented around benefitting the tenant.

### SUMMARY OF THE INVENTION

Disclosed is a method that integrates risk-adjusted-return metrics into a practical application of creating commercial real estate lease structures that benefit both a tenant and its commercial property owner partner.

As mentioned in the previous section, the commercial real estate market focuses almost exclusively on supplier or investor returns. However, the investor does not exist in a vacuum, and the overemphasis on the investor has resulted in a general lack of recognition and lack of understanding in the field of an important principle: A credit tenant's rent obligation is the primary asset for creating value in a building, not the physical building itself.

Thus, in a preferred embodiment of the method, the aforementioned principle is reduced to a practical implementation involving the determination of a tenant's impact on real estate equity. This impact is used to seek an equitable outcome, whether an equitable lease or the creation of “win-win-equal” equity structures for the tenant and its commercial property owner partner.

Entering lease negotiations with a knowledge of the tenant's impact on equity allows for a result tailored to a one-to-one ratio between total lease obligation and tenant equity impact.

Similarly, a successful private equity project results in the credit tenant's return on investment being equal to its landlord partner's return metrics.

Ninety percent of the worth of commercial real estate is tied up in future-value equity or terminal value; by stabilizing future value, allowing the credit tenant to access it via two to five times more present value cash in comparison to the market rates, the tenant is able to “buy down” its commercial real estate profit and loss or present value cost to wholesale pricing, resulting in savings of thirty-five to fifty percent over market rates.

The fact that market rates are significantly higher than the rates obtained by practicing the disclosed invention is a result of the general lack of recognition and understanding in the field of the principles applied in the invention.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 illustrates features and results net operating income benefits of a preferred embodiment of a method of creating equitable commercial real estate lease structures;

FIG. 2 illustrates exemplary steps of a practical application of risk-adjusted return metrics to the creation of a customized equity structure for a tenant and its partners;

FIG. 3 illustrates considerations involved in analyzing a tenant's equity impact;

FIG. 4 illustrates tenant participation in equity;

FIG. 5 illustrates exemplary considerations and outcomes in negotiations involving consideration of tenant's created value;

FIG. 6 illustrates the creation of mutually beneficial equity structures for a tenant and its commercial property owner partner; and

FIG. 7 illustrates the result of the creation of mutually beneficial equity structures.

### DETAILED DESCRIPTION

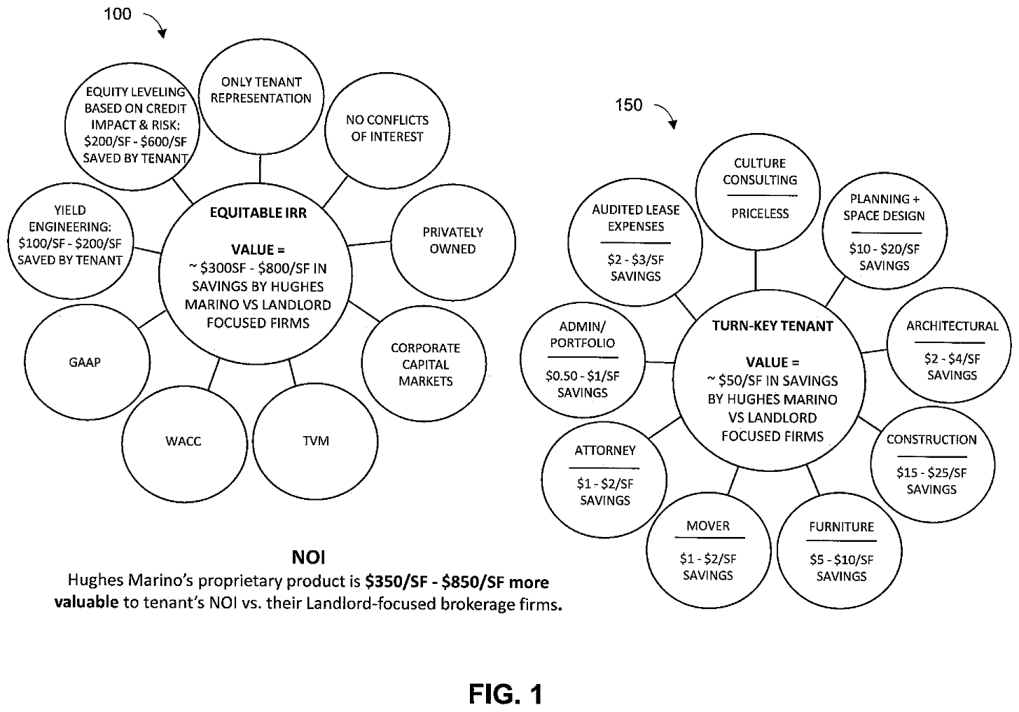

Referring initially to FIG. 1, a general overview of a preferred embodiment of a method of creating equitable commercial real estate structures is illustrated and generally designated 100. Method 100 involves equity leveling based on credit impact and risk in order to provide savings to a tenant over traditional market leasing. More particularly, method 100 uses a variation of investor rate of return metrics in order to provide the practical application of identifying the equity created by a credit tenant and leveraging the created value as shared equity to reduce the tenant's commercial real estate costs.

Many commercial real estate leases include “turnkey tenant improvements” in which the landlord manages building out office or other commercial space for the tenant. A prospective tenant is often unaware of the risks and potential additional costs of turnkey agreements, particularly with regard to extra charges for adaptations to particular needs of the tenant that may deviate from the standard items covered in the turnkey agreement, Additional advising, review, planning, construction, moving, and related services can potentially save significant amounts of money for a prospective tenant, and are generally designated 150.

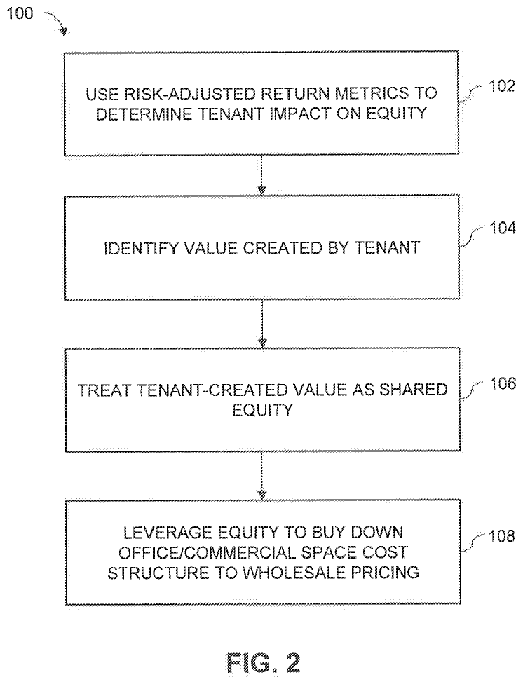

Referring now to FIG. 2, a general overview of steps performed in a preferred embodiment of method 100 is illustrated. Method 100 of creating equitable commercial real estate lease structures includes step 102 of using risk-adjusted return metrics to determine a tenant's impact on commercial real estate equity, step 104 of identifying value created by the tenant, step 106 of treating tenant-created value as a form of shared equity, and step 108 of leveraging that shared equity to buy down the office or commercial space cost structure to a lower pricing analogous to wholesale rather than retail pricing.

Step 102 involves a reversal of the traditional use of risk-adjusted investor rate of return metrics, and its application in the method is therefore generally unrecognized and not understood in the art, More particularly, instead of focusing the risk-adjusted return method on the investor-landlord, the metric is used to determine the tenant's unique impact on equity value in order to identify the value created by the tenant for the investor-landlord in step 104, an effective reverse-engineering of the metric.

When the value created by the tenant is identified in step 104, the tenant-created value is treated as shared equity, as illustrated in step 106. This allows the tenant to have an equal seat at the negotiation table with its landlord partners or potential landlord partners, because the tenant understands how its office leases or occupancies create yield and equity value for itself and the landlord partners. Moreover, the tenant will know how to access a fair portion of its equity through structured approaches, often in the form of trading present value (PV) for terminal value (TV), allowing the tenant to effectively buy down its commercial real estate profit and loss (P&L) and/or PV cost in step 108. The result tends to be savings of 35-50% or more in comparison to traditional market leases.

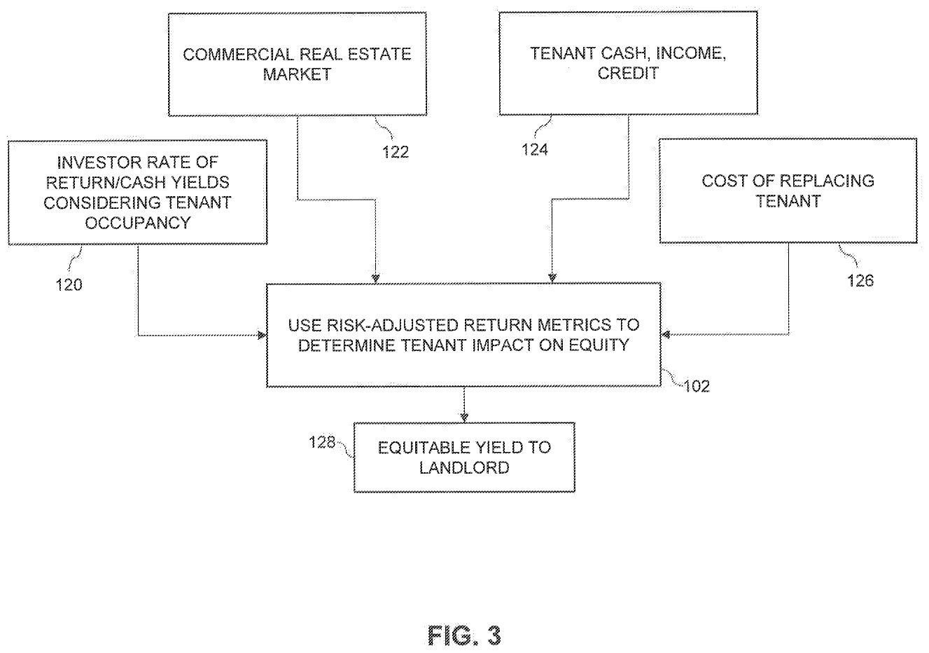

Referring now to FIG. 3, in performing step 102 of using risk-adjusted return metrics to determine a tenant's impact on commercial real estate equity, exemplary considerations used in some preferred embodiments include the investor's rate of return or cash yields 120 resulting from the tenant's occupancy, the state of the commercial real estate market 122, the tenant's cash, income, and credit 124, and the cost to replace tenant 126. Taking these and other relevant facts into consideration, the equitable yield 128 to the landlord is determined. This inversion of risk-adjusted return metrics focuses on the value provided by the tenant, identified in step 104 (shown in FIG. 2) as a result of the application of risk-adjusted return metrics in step 102, as opposed to traditional methods that focus solely on the landlord's interests.

The value provided by the tenant can be substantial. For example, a credit tenant, such as an anchor tenant with an AAA credit score, can increase the terminal value of a building by 30-45%. Since 50-90% of commercial real estate value is tied up in terminal value, the credit tenant creates significant equity for the investor-landlord.

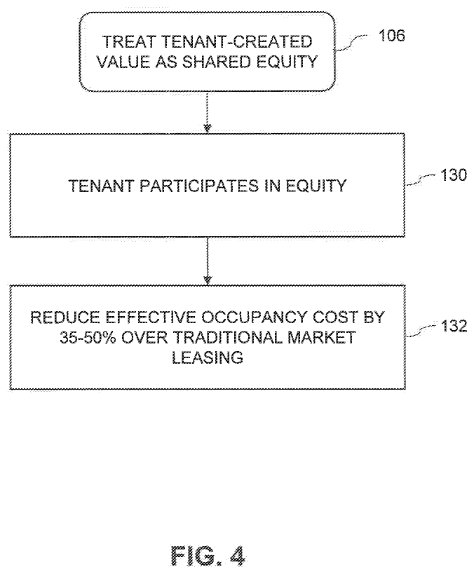

Referring now to FIG. 4, a preferred embodiment of step 106 of method 100 is illustrated. Steps 102 and 104 (shown in FIG. 2) provide an understanding of the value created by a tenant, thus enabling the tenant to participate equitably and knowingly in the increased value their lease obligation creates. This participation is illustrated in step 130 as part of step 106 of treating tenant-created value as shared equity.

The “shared equity” results in the tenant receiving a significantly reduced effective occupancy cost, as illustrated by step 132. A typical reduced effective occupancy cost resulting from method 100 is 35-50% lower than traditional market leasing.

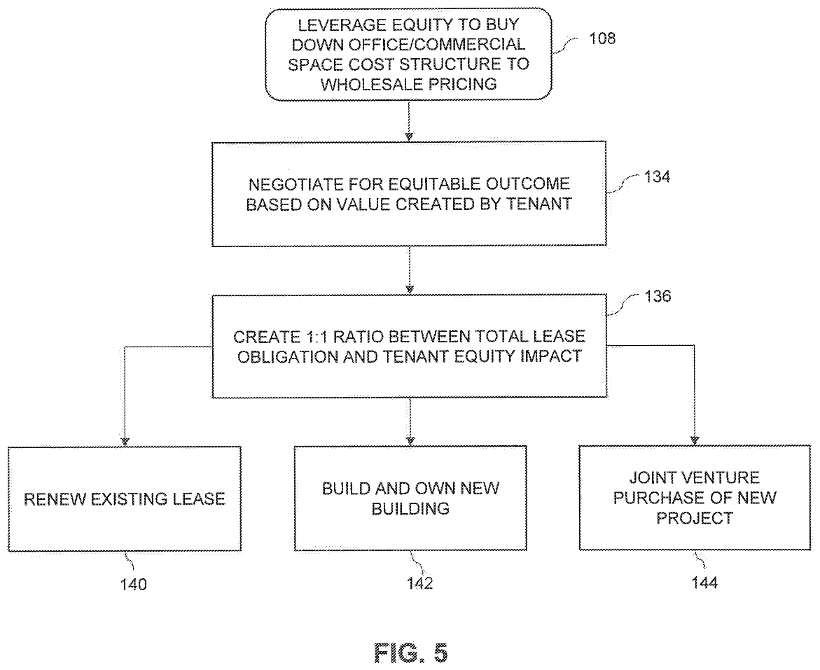

Referring now to FIG. 5, a preferred embodiment of step 108 of method 100 is illustrated. Step 108 involves leveraging value created by the tenant to buy down the cost structure of the office space or commercial space to a reduced effective occupancy cost analogous to wholesale pricing: As mentioned above, the resulting cost is typically 35%-50% lower than traditional market leasing.

In order to obtain this result, step 107 includes step 134 of negotiating for an equitable outcome based on the value created by the tenant. Step 134 is possible because the value created by the tenant is known as a result of performing steps 102 and 104 (shown in FIG. 2). When successful, the result is the creation of a one-to-one ratio between the total lease obligation, and the tenant's impact on equity, as illustrated in step 136.

Method 100 is designed to result in an equitable outcome, but the nature of the ultimate outcome of negotiations 134 seeking to create the one-to-one ratio of step 136 varies according to the tenant's particular situation, needs, and interests. Some exemplary outcomes are illustrated and include the renewal 140 of an existing lease, building and owning 142 a new building, and a joint venture purchase 144 of a new project. The illustrated outcomes are non-exhaustive, and a particular tenant's outcome can include one or more of these or other scenarios.

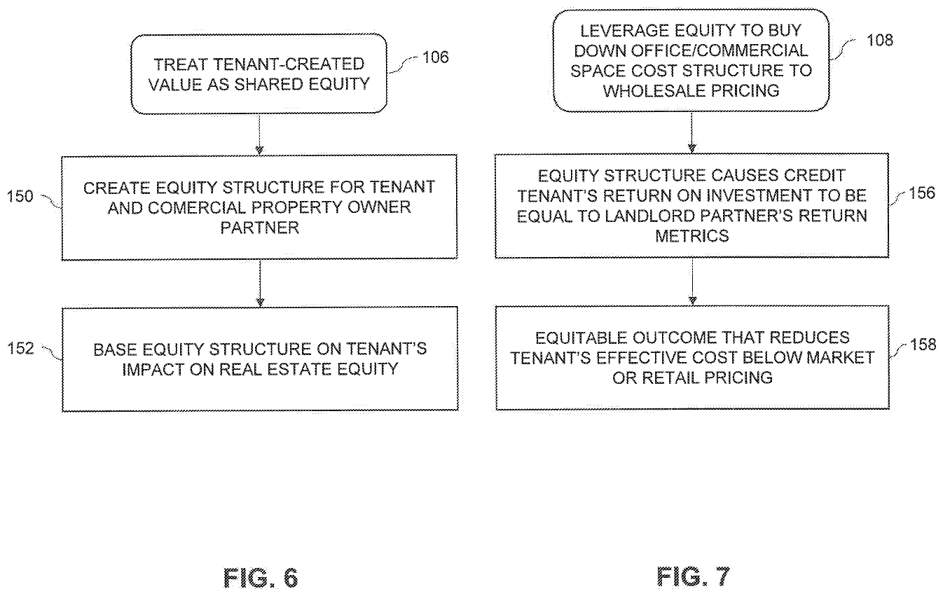

Referring now to FIG. 6, an alternate preferred embodiment of step 106 of method 100 is illustrated. In the illustrated embodiment, step 106 of treating tenant-created value as shared equity involves step 150 of creating a “win-win-equal” equity structure for the tenant and its commercial property owner partner. As illustrated by step 152, the structure is “win-win-equal” because it is based on the tenant's impact on the commercial real estate equity. In other words, it is designed with consideration of the value created by the tenant for its commercial property owner partner, as determined in steps 102 and 104 (shown in FIG. 2).

Referring now to FIG. 7, an alternate preferred embodiment of step 108 of method 100 is illustrated. Step 108 involves leveraging value created by the tenant to buy down the cost structure of the office space or commercial space to a reduced amount. Step 150 (shown in FIG. 6) involved the creation of an equity structure described herein as “win-win-equal.” Step 156 illustrates a key aspect of a preferred meaning of “win-win-equal,” namely that the equity structure is designed to cause the credit tenant's return on investment to be equal to its landlord partner's return metrics. The result, illustrated in step 153, is an equitable outcome that reduced the tenant's effective cost below market or retail pricing.

Referring back to FIGS. 1 and 2, method 100 involves the use of risk-adjusted return metrics, illustrated in step 102, in a manner previously unheard of in the art: The metrics are effectively reverse-engineered to identify the value created by the commercial property tenant for the investor-landlord, as illustrated by step 104. Since 60-90% of commercial real estate worth is tied up in future value—equity and terminal value, by stabilizing future value, the credit tenant is able to access it via present value cash and buy down its commercial real estate cost to what is effectively wholesale pricing compared to market leasing; the outcome is improved between two and five times over market leasing.

Future value is improved and stabilized by mitigating risks with respect to credit, leverage, rent and its growth, tenancy size, and term length. Effectively, risk is lowered, then present value is traded for terminal value.

While there have been shown what are presently considered to be preferred embodiments of the present invention, it will be apparent to those skilled in the art that various changes and modifications can be made herein without departing from the scope and spirit of the invention.

What is claimed is:

1. A method of creating equitable commercial real estate lease structures, comprising the steps of:
determining tenant impact on equity using risk-adjusted return metrics;
identifying value created by a tenant;
treating tenant-created value as shared equity; and
leveraging shared equity to buy down the space cost structure to wholesale pricing.

2. The method of creating equitable commercial real estate lease structures as recited in claim 1, wherein the step of determining tenant impact on equity includes consideration of:
cash yields resulting from the tenant's occupancy;
the state of the commercial real estate market;
the tenant's cash, income, and credit; and
cost to replace tenant.

3. The method of creating equitable commercial real estate lease structures as recited in claim 1, wherein the step of treating tenant-created value as shared equity comprises the steps of:
creating an equity structure for the tenant and the tenant's commercial property owner partner; and
basing the equity structure on the tenant's impact on the commercial real estate equity.

4. The method of creating equitable commercial real estate lease structures as recited in claim 3, wherein the step of creating an equity structure for the tenant and the tenant's commercial property owner partner involves consideration of the value created by the tenant for the tenant's commercial property owner partner.

5. The method of creating equitable commercial real estate lease structures as recited in claim 4, wherein the step of treating tenant-created value as shared equity allows the tenant to participate in equity in the step of leveraging equity to buy down the space cost structure to wholesale pricing, resulting in a reduced effective occupancy cost over traditional market leasing.

6. The method of creating equitable commercial real estate lease structures as recited in claim 1, wherein the step of leveraging shared equity to buy down space cost structure to wholesale pricing comprises trading present value for terminal value.

7. The method of creating equitable commercial real estate lease structures as recited in claim 1, wherein the step of leveraging shared equity to buy down space cost structure to wholesale pricing comprises the steps of:
negotiating for equitable outcome based on the value created by the tenant; and
creating a one-to-one ratio between the total lease obligation and the tenant's equity impact.

8. The method of creating equitable commercial real estate lease structures as recited in claim 7, wherein the step of creating a one-to-one ratio between the total lease obligation and the tenant's equity impact seeks an outcome selected from the group consisting of renewal of an existing lease, building and owning a new building, and a joint venture purchase of a new project.

9. The method of creating equitable commercial real estate lease structures as recited in claim 6, wherein the step of creating a one-to-one ratio between the total lease obligation and the tenant's equity impact results in an equity structure that causes the tenant's return on investment to be equal to the landlord's return metrics.

10. The method of creating equitable commercial real estate lease structures as recited in claim 9, wherein the tenant's effective cost is below market pricing.

11. A method of creating equitable commercial real estate lease structures, comprising the steps of:
providing a property owned by a property owner and having space sought for lease by a tenant;
entering lease negotiations with knowledge of the tenant's impact on equity; and
creating a lease structure having a one-to-one ratio between the tenant's total lease obligation and the tenant's impact on equity.

12. The method of creating equitable commercial real estate lease structures as recited in claim 11, wherein the property comprises commercial real estate.

13. The method of creating equitable commercial real estate lease structures as recited in claim 11, wherein the property comprises office space.

14. The method of creating equitable commercial real estate lease structures as recited in claim 11, wherein the step of entering lease negotiations with knowledge of the tenant's impact on equity comprises the steps of:
determining tenant impact on equity using risk-adjusted return metrics; and
identifying value created by a tenant.

15. The method of creating equitable commercial real estate lease structures as recited in claim 14, wherein the step of determining tenant impact on equity includes consideration of:
cash yields resulting from the tenant's occupancy;
the state of the commercial real estate market;
the tenant's cash, income, and credit; and
cost to replace tenant.

16. The method of creating equitable commercial real estate lease structures as recited in claim 14, wherein the step of creating a lease structure having a one-to-one ratio between the tenant's total lease obligation and the tenant's impact on equity comprises the steps of:
treating tenant-created value as shared equity; and
leveraging shared equity to buy down the space cost structure to wholesale pricing.

17. The method of creating equitable commercial real estate lease structures as recited in claim 16, wherein the step of leveraging shared equity to buy down space cost structure to wholesale pricing comprises trading present value for terminal value.

18. The method of creating equitable commercial real estate lease structures as recited in claim 16, wherein the lease structure is based on the tenant's impact on the commercial real estate equity.

19. The method of creating equitable commercial real estate lease structures as recited in claim 16, wherein the step of treating tenant-created value as shared equity allows the tenant to participate in equity in the step of leveraging equity to buy down the space cost structure to wholesale pricing, resulting in a reduced effective occupancy cost over traditional market leasing.

20. The method of creating equitable commercial real estate lease structures as recited in claim 16, wherein the step of creating a one-to-one ratio between the total lease obligation and the tenant's equity impact results in an equity structure that causes the tenant's return on investment to be equal to the landlord's return metrics.
